(19) United States
(12) Patent Application Publication
(10) Pub. No.: US 2002/0179439 A1
(43) Pub. Date: Dec. 5, 2002

(54) Microelectronic system and method of use and fabrication

(76) Inventors: Tsu-Tseng Weng, Taipei (TW); Jenn-Han Chen, Taipei (TW); Ching Ho, Taipei (TW)

Correspondence Address: J.C. Patents, Inc., Suite 114, 1340 Reynolds Ave., Irvine, CA, 92614, US

(21) Appl. No.: 09/871,209

(22) Filed: May 31, 2001

(51) Int. Cl. G01N 27/26

(52) U.S. Cl. 204/400

(57) ABSTRACT

The invention provides a microelectronic system, which can actively carry out and control molecular biological reactions in microscopic formats. The microelectronic system is accomplished by using electrochemical detection for bulge sites in binding pairs, in order to enhance sensitivity without marking the probe with reporter groups. Together with electrical stringency control, the method can be fully automated with minimum sample preparation. The present invention is especially useful for diagnosing base pair mismatches in target sequences by using specific metal complexes for detection.

### BACKGROUND OF THE INVENTION

1. Field of Invention

The present invention relates to the design, fabrication, and uses of a microelectronic system, which can actively control and carry out multiplex reactions in microscopic formats. More particular, the present invention relates to the design, fabrication, and uses of a microelectronic system, which can actively carry out and control molecular biological reactions, such as nucleic acid hybridization, antibody/antigen reactions and clinical diagnostics in microscopic formats.

2. Description of Related Art

A wide variety of molecular biology techniques for analyzing nucleic acid and protein form the basis of clinical diagnostic assays. These techniques include nucleic acid hybridization analysis, restriction enzyme analysis, genetic sequence analysis, and separation and purification of nucleic acids and proteins.

The majority of molecular biology techniques are complex and time consuming, involving numerous manual operations (e.g., pipetting) on a large number of samples. Moreover, these techniques generally require a high degree of accuracy, not easily achieved by manual operations. Such a technique, for example, nucleic acid hybridization, is limited in its application by a lack of sensitivity, specificity, or reproducibility.

Nucleic acid hybridization analysis involves the detection of a very small numbers of specific target nucleic acids (DNA or RNA) with probes among a large amount of non-target nucleic acids. In order to discriminate the target nucleic acid from undesired non-target nucleic acids (i.e., high specificity), hybridization is normally carried out under the most stringent condition, achieved through a combination of temperature, salts, detergents, solvents, chaotropic agents, and denaturants along with subsequent washing procedures. Unfortunately, the application of these stringency conditions, referred as stringency control, causes a significant decrease in the number of hybridized probe/target complexes for detection.

For the most nucleic acid-based clinical diagnostic assays, it is necessary to detect low copy number nucleic acid targets. But for the current nucleic acid hybridization methods, it remains difficult to detect low copy number nucleic acid targets even with the most sensitive reporter groups (enzyme, fluorophores, radioisotopes, etc.) and associated detection systems. Besides, high level of non-specific background signal, resulting from the affinity of DNA probes to other materials or un-removed fluorophores in the medium, can cause difficulty in detection.

Multiple sample nucleic acid hybridization analysis on micro-formatted multiplex or matrix devices has been disclosed, attaching specific DNA sequences to very small specific areas of a solid support, such as micro-wells of a DNA chip. Photolithographic techniques in combination with electrophoresis techniques have been suggested for synthesizing or analyzing nucleic acids. Nucleic acids of different sizes, charges, or conformations are routinely separated by their differential mobility in an electric field. However, the detection of hybridized complexes is still complemented by using an associated fluorescent imaging detector system. Therefore, the underlying problems of detection relating to sensitivity still exist. Furthermore, repetitive washing steps are required for eliminating background signals before detection, increasing complexity of operation.

### SUMMARY OF THE INVENTION

The invention provides a microelectronic system, which can actively carry out and control molecular biological reactions in microscopic formats. The microelectronic system is accomplished by using electrochemical methods for detection, in order to enhance sensitivity without marking the probe with reporter groups. The present invention is especially useful for diagnosing base pair mismatches in target sequences by using specific metal complexes for detection.

By using the metal complex compound, high specificity has been shown toward nucleic acids containing bulge sites. By detecting bulges, this invention is especially useful in detecting one or few mismatches (or mutations) in test nucleic acids, without complete nucleic acid sequencing. The present invention using the electrochemical detection method allows for rapid (in ranges of millisecond) direct measurement of nucleic acid in the low concentration range. The electrochemical detection method provides a direct quantitative measure of the specific nucleic acid targeted by each probe in the electrode. Rapid evaluation of multiple gene effects per sample is accomplished by multiplexing the working electrodes with various probes.

Minimum test sample preparation is required, while no extensive and repetitive washing is necessary. No amplification or complicated purification of the sample is needed prior to detection. Because of the electrochemical detection, the method of the present invention and apparatus thereof can be fully automated, with a short reading time.

The present invention using electrical addressing of the probe molecules and electrical stringency control of hybridization not only accelerates the basic hybridization process, but also enhances discrimination of single base mismatches in target sequences.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 shows a basic design of micro-locations fabricated using photolithographic techniques according to one preferred embodiment of this invention;

FIG. 2 shows a matrix type microelectronic system according to one preferred embodiment of this invention;

FIGS. 3A to 3E show the cross-sectional views of the fabrication steps for the microelectronic system according to one preferred embodiment of the present invention;

FIG. 4 shows a sample deliver system according to one preferred embodiment of this invention; and

FIG. 5 shows a probe loading system according to one preferred embodiment of this invention.

### DESCRIPTION OF THE PREFERRED EMBODIMENTS

The system and the related methodologies of this invention allow exceptional sensitivity and rapid direct measurement of nucleic acid by using electrochemical methods. The system and the related methodologies of this invention further allow important biological and diagnostic reactions to be carried out under complete electronic control. The basic concept of this invention is a microelectronic device with specially designed microscopic locations. Each micro-location has a derivatized surface for the covalent attachment of specific binding entities (i.e., an attachment layer), a permeation layer, a surrounding counter electrode and a central working electrode. Each specific micro-location is addressed with specific binding entities by spot electroplating. The multiplex reactions are carried out at the micro-locations. Through the electrodes, analytes and reactants can be electronically concentrated to or repelled from any micro-locations. Furthermore, probe-coupled electrodes along with electrochemical detection method can detect target nucleic acids without the need for sample amplification or the use of fluorescent, chemiluminescent or radioactive labels. The ability of the system to electronically control nucleic acid hybridization reactions together with electrochemical detection provides new and important advantages and improvements.

### General Design of the Microelectronic System

In general, the microelectronic system of the present invention with a plurality of micro-locations is fabricated using photolithography (microlithography) techniques. The micro-locations can be of any shape, preferably round, square, or rectangular. The size of an addressable micro-location can be of any size, ranging from sub-micron to several centimeters, with 0.2 mm to 1.0 mm being the most preferred size range for devices fabricated using photolithographic techniques.

For carrying out the electrical stringency control and for electrochemical detection, microelectrodes are arranged based on the various functions in the system. Each micro-location must have at least a surrounding counter (ground) electrode and a central working electrode for active electrical operation. The functioning working microelectrode can affect or cause the free field electrophoretic transport of charged specific binding entities, or analytes (target sequences) to or from any micro-location, together with the counter electrode. For each micro-location, a corresponding reference electrode will be applied during electrochemical detection.

The basic concept of electrical stringency control is applied in the present invention, together with electrical addressing of (probe) binding entities. Using the functioning electrodes, the specific binding entities are concentrated and covalently attached to the specially modified surface of the specific micro-location, through free field electrophoresis. Moreover, the analytes are concentrated and transported by the functioning electrodes to the micro-locations for hybridization. After hybridization of the binding entities with analytes (target sequences), unbound analytes can be washed out from the micro-locations with the help of repelling by reversed potentials.

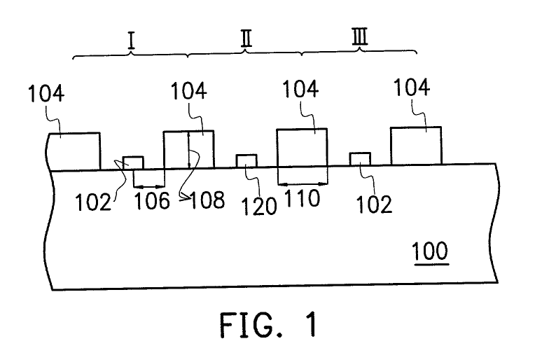

FIG. 1 shows a basic design of micro-locations fabricated using photolithographic techniques. The micro-locations (I, II, III) are formed on the surface of an insulating/base material layer 100. For each micro-location, the central metal bulge serves as the working microelectrode 102. With a distance, the surrounding metal cylindrical block around the central working electrode serves as the counter electrode 104. The counter electrode 104 surrounding the central working electrode 102 encloses a space, which space is referred as a (loaded) volume of the micro-location.

The probe samples (binding entities) will be loaded into the space between the working electrode and the counter electrode. Therefore, the loaded amount of the probe sample will depend on the size of the micro-locations, which is defined by a distance 106 between the working electrode 102 and the counter electrode 104 and the height 108 of the counter electrode 104. The loaded amount of the probe samples will require careful calculations, in order to prevent contamination between neighboring micro-locations. Taking the round micro-location as an example, if the micro-location has a diameter of approximately 0.8 mm. and the counter electrode has a height of approximately 1.0 mm., the micro-location can hold about 0.2 microliters (μl) of probe sample solution. Each micro-location uses a width of the counter electrode as spacing between neighboring micro-locations.

In the present invention, electrochemical method is used for detection. However, if optical method is considered, the region between the working electrode and the counter electrode of the micro-location can be used for optical detection. The materials for the insulating/base material layer 100 include, but are not limited to, plastic, polyester (PET), polyimide (PI), polystyrene (PS) or even glass materials.

After creating micro-locations by using photolithographic techniques, chemical methods are used to create the specialized attachment layer. The attachment layer provides a base for the covalent binding of the binding entities. The specific binding entities are covalently coupled to the attachment layer, and form a specific binding entity layer. The specific binding entity layer is usually a monolayer of the specific binding molecules. However, in some cases the binding entities can directly attach to the DNA probes without the binding layer.

Self-assembled monolayer techniques are utilized to immobilize probes (binding entities) on the microelectrodes. If the surface of the electrode is made of gold (Au), several chemicals, such as, aminoethanethiol or mercaptohexanol (MCH), can be used to treat the surface of the electrode in order to form an active self-assembled monolayer. For example, the clean, bare gold surface of the electrode is immersed in a 1 mM thiolated, single-stranded DNA (HS-ssDNA) solution, and then exposed to a 1 mM MCH solution. MCH not only passivates the surface for preventing non-specific absorption of DNA, but also displaces absorbed HS-ssDNA through some functionality other than the thiol groups. Alternatively, an active self-assembled monolayer is formed by coating aminoethanethiol on the electrode surface. With the presence of imidazole, and the 5′-terminal phosphated end of ssDNA forms a phosphormidate bond with the amino group of aminoethanethiol.

Moreover, with an electrical field applied by the negative-biased working electrode and an additional positive-biased electroplating electrode, positive-charged terminals of binding entities are attracted by the negative biased working electrode. Because electrical propulsion provides rapid transportation for binding entities, the binding entities can react with the attachment layer and become immobilized. By applying the electrical field, the binding entities are attached to the attachment layer in a specific order, thereby forming an ordered monolayer.

The permeation layer provides spacing between the metal surfaces and provides supports for the binding entities, so that the binding entities can adopt better, three-dimensional orientations for further reactions or hybridization. Preferably, materials for forming the permeation layer can be biomolecules with liquid crystallinity, for example, chitin, chitinous monosaccharides or its analogous oligosaccharides. Similar materials with liquid crystal chiral properties are within the scope of the present invention.

The design and functions of the permeation and attachment layer are closely related to the physical (e.g., size and shape) and the chemical properties of the specific binding entity molecules. They are also dictated to some extent by the physical and chemical properties of the reactant molecules and target molecules, which will be subsequently transported and bound to the micro-location. For example, if large binding entities are used, appropriate modification of the attachment layer will have to be carried out so as to either reduce the number of large binding entities or provide more spacing between the binding entities on the surface.

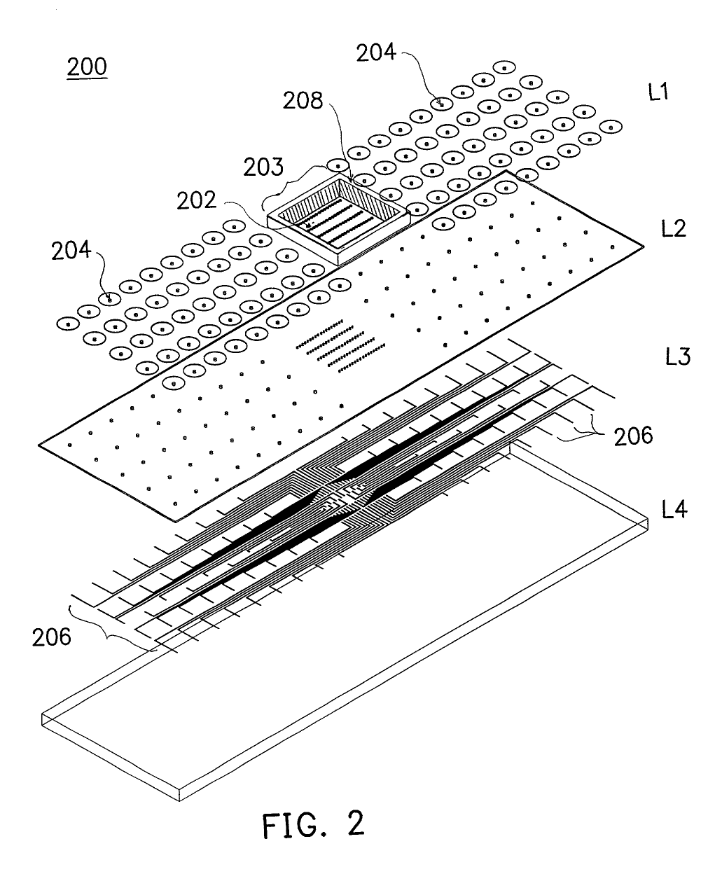

FIG. 2 shows a matrix type microelectronic system 200 containing 90 micro-locations 202 in an exploded view. Such a system is fabricated on a double-sided copper foil film attached to a substrate approximately 10 cm.×.2.5 cm, with a central area approximately 10 mm.×10 mm. containing the 90 micro-locations, for example. The system can be dissected as four layers, L1 (for reaction and detection), L2 (for insulation and isolation), L3 (electrical circuit) and L4 (substrate). Three layers L1, L2 and L3 consist of the double-sided copper foil film. The layer L1 includes the micro-locations 202 in a central block region 203 and outer metal contact pads 204 distributed around the central block region 203. Each micro-location 202 is connected to a corresponding outer contact pad 204 through connective circuitry 206. The connective circuitry 206, consisting of L3, is electrically connected to each individual working microelectrode of the micro-location and extends outwardly in contact with an outer metal contact pad 204 on L1 through interlayer plugs (not shown). The wires pattern of the connective circuitry 206 includes outside wires 210 electrically connected to the metal contact pads 204 and center wires array 212 electrically connected to microelectrodes of the micro-locations. The pattern design or layout of the connective circuitry depends on the number and distribution of the micro-locations. For independently providing electrical potentials to any contact pads and measuring the resulting currents in each micro-location, a computer control/data collection unit can be integrated into the microelectronic system. The aforementioned microelectronic system can be plugged into a microprocessor controlled power supply and multimeter apparatus that can control and operate the system.

### Micro-lithographic Fabrication Steps

General photolithographic techniques can be used for the fabrication of the microelectronic system, which has a large number of small micro-locations. The 90 micro-location system 200 shown in FIG. 2 can be fabricated using relatively simple mask design and standard photolithographic techniques.

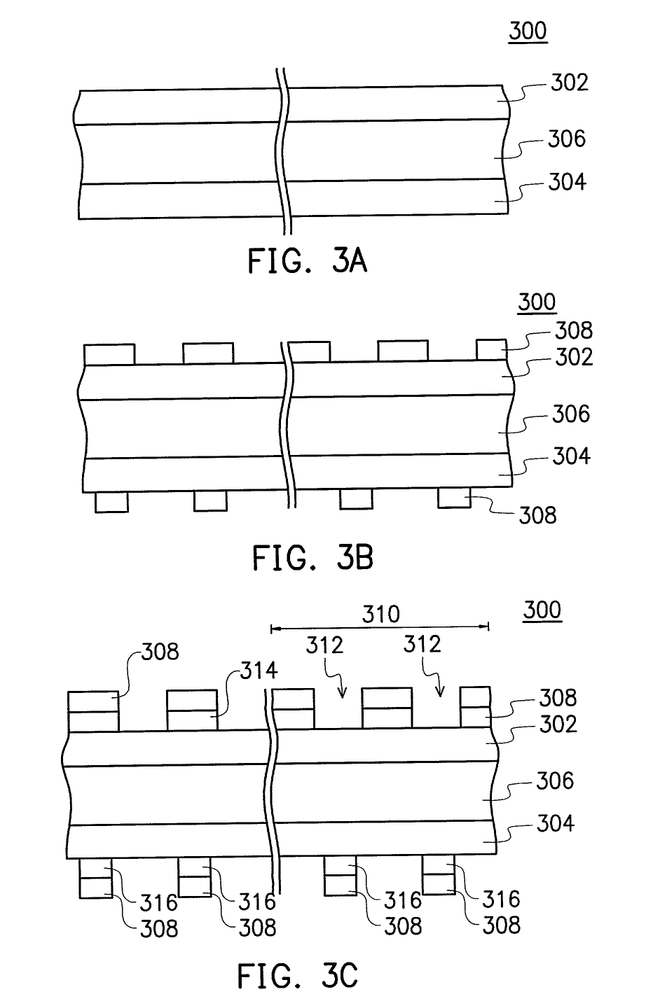

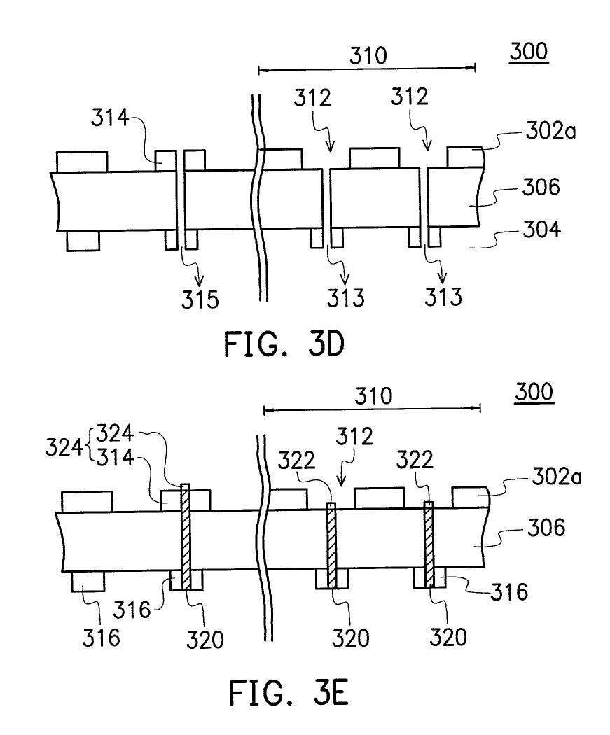

FIGS. 3A to 3E show the cross-sectional views of the fabrication steps for the microelectronic system according to one preferred embodiment of the present invention. Referring to FIG. 3A, a double-sided metal (copper) foil film 300 is provided, including a front metal (copper) layer 302, a rear metal (copper) surface 304 and a core layer 306 (i.e. the insulating/base material layer shown in FIG. 1) in-between. For example, the material for the core layer 306 would be plastic, polyimide (PI), polyester (PET), polystyrene (PS) or glass with approximately 1 millimeter in thickness. Even though a double-sided copper foil film is taken as an example herein, the scope of the present invention will not be limited by the embodiments. Any appropriate multi-layered structures that can achieve equivalent functions are within the scope of the present invention. Therefore, the metal materials are not limited to copper only, but including other suitable metals, such as, gold, silver, tin, aluminum, platinum, palladium, carbon, and various metal combinations.

After the conventional photolithographic processes with masks, the layout of connective circuitry (L3) and the pattern of L1 are accomplished.

Referring to FIG. 3B, the front copper layer 302 and the rear copper layer 304 are respectively coated with one patterned photosensitive photoresist layer 308. The material of the photoresist layer can be photosensitive polyimide, epoxy or any suitable polymer material using an UV light source. The photosensitive photoresist layer 308 can be formed by, for example, screen-printing with the layout pattern. Alternatively, the photoresist layer can be formed, patterned with photo-masks and then developed by conventional photolithography and etching techniques.

Referring to FIG. 3C, using the patterned photoresist layers 308 as masks, both the front and rear copper layers 302, 304 are patterned to remove portions of copper until the surface of the core layer 306 is exposed. In the patterned front copper layer 302, a central block region 310 (i.e. the central region 203 shown in FIG. 2) having a plurality of round holes 312 is formed, together with a plurality of round metal blocks 314. The round holes 312 are to form micro-locations, while the round metal blocks 314 are to form outer contact pads. Accordingly, the rear copper layer 304 is patterned to form connective circuitry 316 (i.e. connective circuitry 206 as shown in FIG. 2).

Next, as shown in FIG. 3D, a drilling process is performed to drill small holes (boreholes) through the core layer 306 and the rear copper layer, in centers of the round holes 312 and the round metal blocks 314, thus forming first boreholes 313 and second boreholes 315 respectively in the round holes 312 and the round metal blocks 314. The drilling process can be implemented by, for example, mechanical drilling assisted by laser-alignment.

Referring to FIG. 3E, a plating through-hole (PTH) process is performed to form metal plugs 320 through the core layer 306 by filling up the first and second boreholes, so that metal bulges 322, 324 are formed on openings of the first and second boreholes respectively. The metal bulges 322 in the centers of the round holes 312 serve as working electrodes in the micro-locations, while the central block region 310 serves as counter electrodes for the micro-locations. The round metal blocks 314 and the metal bulges 324 consist of outer contact pads 332. The outer contact pads 332 can used for detecting electrical properties of a single electrode or for further electrical operation. The plugs 320 in the first and second boreholes keep the connective circuitry 316 connected to the working electrodes 322 and the outer contact pads 332. Generally, the plating through-hole process includes at least an electroless plating process and an electrical plating process.

Next, further surface treatments, for example, sequential chemical electroplating nickel and gold, are performed to the exposed metal surfaces of both surfaces of the copper foil film 300. The surface treatments are performed to prevent oxidation and enhance surface properties for the following processes.

Next, attach the processed double-sided copper foil film 300 to a substrate 340. The substrate 40 provides support for the other layers and further insulation for the backside of the double-sided copper foil film 300. Suitable substrate materials includes glass, plastic, polyester (PET), polyimide (PI), polystyrene (PS) or even ceramic materials, depending on various considerations for the design and fabrication of system, such as, support strength, material compatibility, the subsequent reactants and analytes, and the number of micro-locations. In some cases, if the core layer is strong enough to provide supports for the other layers, the substrate can be omitted.

Furthermore, referring back to FIG. 2, a retaining wall 208 is attached around the central block region 203 for preventing the liquid from spilling. The retaining wall 208 can be made of, for example, polyvinyl acetate by ultrasonic thermal fusion.

For the yield control, electrical methods are applied to measure conductivity of each individual electrode, with diluted sodium hydroxide solution filled in the retaining wall.

At this point the microelectrodes in the micro-locations are ready to be modified with a specific attachment layer. The objective is to create an attachment surface layer with optimal binding properties on the microelectrode. After the surface treatments, the surface of the electrode is made of gold (Au), for example. Several chemicals, such as, aminoethanethiol or mercaptohexanol (MCH), can be used to treat the gold surface of the electrode in order to form an active self-assembled monolayer. Preferably, a probe sample solution including at least binding entities and attaching agents is loaded in to the micro-location, with an applied electrical field. The probe sample solution can further include biomolecules with liquid crystallinity, for example, chitin, chitinous monosaccharides or its analogous oligosaccharides, as permeation agents do.

For example, the clean, bare gold surface of the electrode is exposed to a 1 mM thiolated, single-stranded DNA (HS-ssDNA) solution, and then to a 1 mM MCH solution. With the presence of the electrical field, the ssDNA binding entities are immobilized onto the working electrode surface through the thiol groups in a specific order. Alternatively, an active self-assembled mono-layer is formed by coating aminoethanethiol on the electrode surface. With the presence of imidazole, and the 5′-terminal phosphated end of ssDNA forms a phosphormidate bond with the amino group of aminoethanethiol. While it represents several of the preferred approaches, a variety of other attachment reactions are possible for both the covalent and non-covalent attachment of many types of binding entities.

The applied electrical field, from the negative-biased working electrode and an additional positive-biased electroplating electrode, helps attach the binding entities onto the surface of the working electrodes with the help of attaching agents, which process is called spot electroplating. By applying the electrical field, the binding entities are attached onto the electrode in a specific order, thereby forming an ordered mono-layer in a self-assembled style. Preferably, the binding entities are positive-charged, so that the bonding entities are attracted and bonded to the negative-biased working electrode by electrophoresis. The electrical polarity of the electrodes can be reversed, depending on the properties of the binding entities.

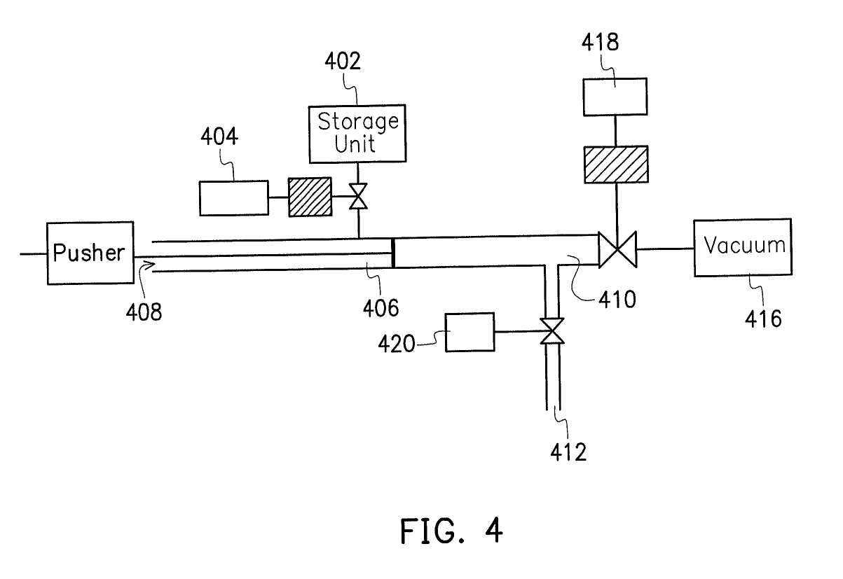

This spot electroplating process can be implemented by a sample delivery system. As shown in FIG. 4, the sample delivery system 400 has a storage unit 402 for storing the probe sample solution. For example, a first valve 404 or equivalent means can be used to control the flow of the sample solution. A determined amount of sample solution is released into a branched tube 406 via an inlet. The branched tube 406 has a first terminal opening 408 coupled to a pusher 414, a second terminal opening 410 coupled to a vacuum pump 416 and a third terminal opening 412 as an outlet for the sample solution. A second valve 418, situated between the second terminal opening 410 and the vacuum pump 416, is used to control the vacuum, while a third valve 420 is located beside the third terminal opening 412 for controlling outflux of the sample solution. During functioning, the pusher 414 can move outwardly, so that the sample solution can be transferred to the tube 406, with the first and second valves 404, 418 opened and the third valve 420 closed. The vacuum can help the sample solution fill up the tube 406 and get rid of possible air bubbles. Afterwards, the pusher 414 moves inwardly to transfer the sample solution toward the outlet, with the third valve 420 opened and the first and second valves 404, 418 closed.

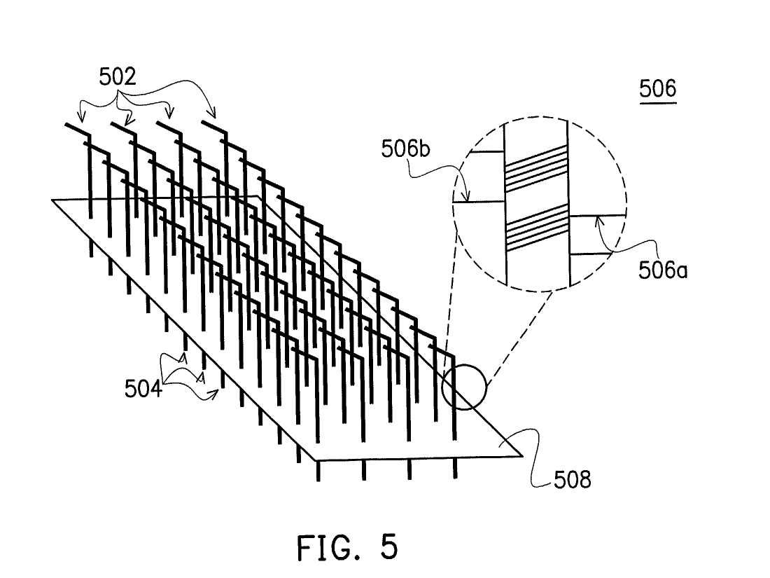

Referring to FIG. 5, a probe loading system 500 is coupled to the aforementioned sample delivery system. Through the outlet of the sample delivery system, the sample solution is transferred to the probe loading system 500. The probe loading system includes a plurality of capillaries 502. Each individual capillary leads the transferred fluid (sample solution) toward its exit 504, so that the fluid can be loaded into the micro-location. Each capillary has a feedback circuit 506 for detecting whether the fluid passes or not. For example, the feedback circuit 506 includes an induction coil 506a and an oscillation coil 506b. A fixture 508, deposed around the lower parts of the capillaries 502 and close to the exits 504, is used to lock the capillaries, so that distances between the capillaries and levels of the capillaries are unvarying. The relative positions of the capillaries correspond to the distribution of micro-locations. Therefore, multi-delivery can be achieved in the present invention. The spot electroplating process can be performed in either serial manner or parallel manner, depending on the numbers of the micro-locations.

After the spot electroplating process, a cap layer (not shown) can be used to further cover the central block region 203 in the aforementioned microelectronic system, so that the micro-locations in the central block region 203 are covered and sealed. Suitable materials of the cap layer include agar or hydrogel materials. Even though the cap layer seals the micro-locations, the following test sample can be injected (loaded) into each micro-locations by penetrating the cap layer. Because the semisolid properties of the cap layer, the cap layer can still maintain substantially seal after injection.

### Electrochemical Detection

Conventionally, hybridization is detected by labeling a target with, e.g., fluorescein or other known visualization agents and incubating the target with an array of oligonucleotide probes. Upon duplex formation by the target with a probe in the array, the fluorescent label is excited by, e.g., an argon laser and detected by viewing the array, e.g., through a scanning confocal microscope.

In order to quantitate hybridization, electrochemical detection method is used in this invention. The electrochemical method can directly detect target nucleic acid without the need for sample amplification or the use of fluorescent labels. The electrochemical method is based on measurement for cleavage of a nucleic acid bulge site in double-stranded nucleic acid molecules, using a metal complex compound, for example, a dyad (bivalent) complex compound.

A nucleic acid bulge site refers to a region of unpaired bases in a double-stranded nucleic acid molecule, the region having at least one unpaired nucleotide and being flanked by two paired nucleotides. Investigations have shown that nucleic acid bulges are related to many biological processes. For example, nucleic acid bulges can produce frameshift mutations that can change the product of protein translation and result in various disorders, such as, cystic fibrosis. Specific RNA bulges are often recognized by proteins (e.g., TAR RNA is recognized by the TAT protein of HIV). Accordingly, bulges or loops are useful in a number of diagnostic applications.

The probes are optionally complexed with complementary nucleic acids with self-complementary regions. After hybridization, complementary nucleic acids, for example, cDNAs, in the test sample are complexed with the single-stranded nucleic acid probes, thus forming double-stranded nucleic acids. If the probes are single-stranded nucleic acids that form unpaired double-stranded nucleic acids with the test sample, nucleic acid bulges will form in the resulting double-stranded nucleic acids after hybridization.

Hybridization complex stability is affected by the length and the degree of complementarity between two base sequence recognition molecules, the nucleotide base recognition groups, and the backbone of the base sequence recognition molecule. If the complexed molecules have internal regions of less than 100% complementarity to each other, bulges are possibly formed in the internal regions. This may be achieved by including mismatches or linker components such as non-nucleotide linkers and abasic “nucleotides”. Moreover, deletion or addition of nucleotides in the probe sequence can cause bulge formation.

The electrochemical detection method is based on measurement of the formed nucleic acid bulges. The electrochemical method specifically cleavages the nucleic acid bulges in double stranded nucleic acids, using a metal complex compound.

The metal complex compound can be shown as formula (I):

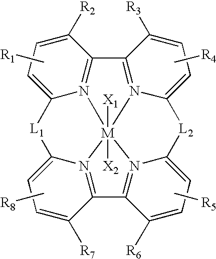

Each of R1, R2, R3, R4, R5, R6, R7 and R8, independently is hydrogen, alkyl, alkoxy, hydroxyl, hydroxylalkyl, halo, haloalkyl, amino, aminoalkyl, alkylcarbonylamino, alkylaminocarbonyl, alkylcarbonyl, alkylcarbonylalkyl, alkoxycarbonyl, alkylcarbonyloxy, cycloalkyl, heterocycloalkyl, aryl, aralkyl, heteroaryl, or heteroaralkyl.

Each of R2 and R3, and R6 and R7, independently, optionally join together to form a cyclic moiety which is fused with the two pyridyl rings to which R2 and R3, or R6 and R7 are bonded. The cyclic moiety, if present, is optionally substituted with alkyl, alkoxy, hydroxyl, hydroxylalkyl, halo, haloalkyl, amino, aminoalkyl, alkylcarbonylamino, alkylaminocarbonyl, alkylcarbonyl, alkylcarbonylalkyl, alkoxycarbonyl, alkylcarbonyloxy, cycloalkyl, heterocycloalkyl, aryl, aralkyl, heteroaryl, or heteroaralkyl.

Each of L1 and L2, independently, is —C(Ra)(Rb)—, —O—, —S—, or —N(Rc)— and each of Ra, Rb, and Rc, independently, is hydrogen, alkyl, cycloalkyl, heterocycloalkyl, aryl, aralkyl, heteroaryl,or heteroaralkyl.

M is a Co, Ni, Ru, Rh, Mn, Os, Ag, Cr, Zn, Cd, Hg, Re, Ir, Pt, or Pd ion, and the oxidation state of M is 0, 1, 2, 3, or 4. Each of X1 and X2, independently, is a labile ligand. A salt of the metal complex compound of formula (I) is also within the scope of the present invention.

Examples of the metal complex compound of formula (I) include cobalt (II) (hexaazacyclophane)(trifuoroacetate)₂, cobalt (II) (hexaazacyclophane)(H2O) (trifuoroacetate), ruthenium (II) (hexaazacyclophane) (trifuoroacetate)₂, and manganese (II) (hexaazacyclophane) (trifuoroacetate)₂.

The metal complex compound mentioned supra could detect the bulge sites and then cleavage the bulge sites. For cleaving the nucleic acid bulges, the metal complex compound is applied in the presence of an oxidant, e.g., hydrogen peroxide, or in a medium having a pH value that ranges from 4-9.

Within the whole reaction system, three electrodes, including the working electrode, the counter electrode and a reference electrode, are applied with the metal complex as a redox-active mediator for hybridization detection based on quantity of the bulge sites. The probe-coupled working electrodes can be used to directly detect the electrical signals from the complexed nucleic acids. In the catalytic cycle, the mediator is oxidized by the electrode, for example, from the (II) form to the (III) form, thus capable of cleaving the bulge site. As a result, electrons are removed from nucleic acids after bulge cleavage and delivered to the solid electrode by the mediator, resulting in a measurable current. Compare the results in the absence or in the presence of the bulge site, the resulting current enhancement is corresponding to the amount of bulge sites, which in turn relates to quantity of hybridized nucleic acids.

No complicated and time-consuming sample preparation, such as, amplification or purification, is required. This eliminates problems typically experienced with other techniques requiring expensive labor-extensive steps. Minimal sample preparation is needed in the present invention. For example, simple cell lysates or basically treated blood samples can be used directly as test samples. Moreover, standard microfluidics technologies can be used to prepare, concentrate or partially separate the desired sample. The sample preparation process can be performed in a microfluidized microstructure included in the aforementioned microelectronic system, or integrated within the microprocessor controlled power supply and multimeter apparatus that can control and operate the system.

After adding the mediator, a potential is applied and then a resultant current is measured.

By using the metal complex compound, high specificity has been shown toward nucleic acids containing bulge sites. By detecting bulges, this invention is especially useful in detecting one or few mismatches (or mutations) in test nucleic acids, without complete nucleic acid sequencing. For example, normal nucleic acid sequence can be used as probe sequence for detecting mutated nucleic acid sequence, including mismatched, deleted or elongated sequence, in the test sample; and vice versa. Preferably, the formed bulge site contains 2 to 10 bases, most preferably, 3 to 6 bases. No further repetitive washing steps are required, since electrochemical detection with high specificity and electrical stringency control are used.

Furthermore, the electrochemical detection method allows for rapid (in ranges of millisecond) direct measurement of nucleic acid in the low concentration (as low as attomole) range. Actual sensitivity is dependent on length and concentration of nucleic acids in the sample.

The electrochemical detection method provides a direct quantitative measure of the specific nucleic acid targeted by each probe in the electrode. Rapid evaluation of multiple gene effects per sample is accomplished by multiplexing the working electrodes with various probes. No amplification or purification of the sample is required prior to detection. Because of the electrochemical detection, the method of the present invention and apparatus thereof can be fully automated, with a short reading time.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A microelectronic system, wherein the microelectronic system includes a reaction region, the system comprising:
a plurality of micro-locations distributed in the reaction region, wherein each micro-location comprises:
a first electrode disposed in a center of the micro-location;
a second electrode surrounding the first electrode with a distance, thus enclosing a space, wherein the second electrode is electrically insulated from the first electrode without loaded fluid;
an attachment layer coupled to a surface of the first electrode;
a plurality of binding entities coupled the attachment layer, wherein the binding entities are immobilized onto the surface of the first electrode through the attachment layer; and
a permeation layer for supporting the binding entities
,wherein the second electrodes isolate the first electrodes, acting as isolating walls, and wherein the space enclosed by the second electrode can hold loaded fluid;
a retaining wall around the reaction region;
a plurality of contact pads disposed outside the reaction region and surrounding the reaction region, for electrical operation;
a connective circuitry for connecting the first electrodes in the micro-locations and the contact pads;
an insulating layer for isolating the micro-locations and the connective circuitry, wherein the micro-locations are disposed on a first surface of the insulating layer and using the insulating layer as a base for the micro-locations, while a second surface of the insulating, opposite to the first surface, is attached to the connective circuitry; and
a cap layer over the micro-locations for sealing the micro-locations.

2. The microelectronic system as claimed in claim 1, wherein a substrate attached to the connective circuitry can be further included for support.

3. The microelectronic system as claimed in claim 2, wherein a material for forming the substrate can be selected from the group consisting of glass, plastic, polyester (PET), polyimide (PI), polystyrene (PS) and ceramic materials.

4. The microelectronic system as claimed in claim 1, wherein a reference electrode applied to each micro-location can be further included for electrochemical detection.

5. The microelectronic system as claimed in claim 1, wherein a solution, including a test sample, a redox-active mediator and an oxidant, can be further included in each micro-location.

6. The microelectronic system as claimed in claim 5, wherein the redox-active mediator is a metal complex compound for assisting electrochemical detection.

7. The microelectronic system as claimed in claim 6, wherein the metal complex compound can be selected from the group consisting of cobalt (II) (hexaazacyclophane)(trifuoroacetate)₂, cobalt (II) (hexaazacyclophane)(H2O) (trifuoroacetate), ruthenium (II) (hexaazacyclophane) (trifuoroacetate)₂, and manganese (II) (hexaazacyclophane) (trifuoroacetate)₂.

8. The microelectronic system as claimed in claim 5, wherein the oxidant is hydrogen peroxide.

9. The microelectronic system as claimed in claim 1, wherein a power supply can be further included.

10. The microelectronic system as claimed in claim 1, wherein a material for forming the insulating layer can be selected from the group consisting of plastic, polyester (PET), polyimide (PI), polystyrene (PS) and glass materials.

11. The microelectronic system as claimed in claim 1, wherein a material for forming the first electrode can be copper.

12. The microelectronic system as claimed in claim 1, wherein a material for forming the first electrode can be selected from the group consisting of copper, gold, silver, tin, aluminum, platinum, palladium, and metal alloys of previous metals.

13. The microelectronic system as claimed in claim 1, wherein a material for forming the second electrode can be copper.

14. The microelectronic system as claimed in claim 1, wherein a material for forming the second electrode can be selected from the group consisting of copper, gold, silver, tin, aluminum, platinum, palladium, and metal alloys of previous metals.

15. A method for fabricating a microelectronic system, compatible with electrochemical detection, the method comprising:
providing a three-layered structure, wherein the three-layered structure comprises a first layer, a second layer and a third layer between the first and second layers stacked together, and wherein the first layer has a central reaction region and a outer region surrounding the central reaction region;
forming a first patterned photoresist layer and a second patterned photoresist layer respectively on the first layer and the second layer;
patterning the first layer to form a plurality of holes in the central reaction region and form a plurality of blocks in the outer region, wherein the remained portion of the first layer in the central reaction region serves as a electrode;
patterning the second layer to form a connective circuitry;
performing a drilling process to form a plurality of first boreholes and second boreholes through the three-layered structure, wherein each first bore is disposed in a center of each hole, while each second bore is disposed in a center of each block;
forming a plurality of first plugs and second plugs to respectively fill up the first and second boreholes, while forming a plurality of first bulges and second bulges respectively on opening of the first and second boreholes on the first layer, wherein the first bulges on the first layer serve as working electrodes and the second bulges on the first layer serve as contact pads, wherein the first and second plugs connect the connective circuitry with the working electrodes and the contact pads;
removing the patterned first and second photoresist layers;
performing surface treatment to exposed surfaces of the three-layered structure;
forming a retaining wall around the reaction region and on the first layer;
attaching binding entities to the working electrodes; and
forming a cap layer to cover the first layer in the central reaction region, so that the central reaction region is sealed.

16. The method as claimed in claim 15, wherein before the step of forming a retaining wall, the method further comprises attaching a substrate to the connective circuitry of the three-layered structure.

17. The method as claimed in claim 16, wherein a material for forming the substrate can be selected from the group consisting of glass, plastic, polyester (PET), polyimide (PI), polystyrene (PS) and ceramic materials.

18. The method as claimed in claim 15, wherein the step of attaching binding entities to the working electrodes further comprises the following steps:
providing a first solution, including the binding entities and attachment agents to the hole in the first layer, so that the first solution is in contact with the working electrode in the hole;
applying a first bias to the working electrode and a second bias to the electrode;
attaching the binding entities to a surface of the working electrode in a self-assembly style by the attachment agents; and
repelling the unattached binding entities from the working electrode.

19. The method as claimed in claim 18, wherein the first bias and the second bias are opposite biases.

20. The method as claimed in claim 18, wherein the first solution can further comprises permeation agents.

21. The method as claimed in claim 15, wherein a material for forming the third layer can be selected from the group consisting of plastic, polyester (PET), polyimide (PI), polystyrene (PS) and glass materials.

22. The method as claimed in claim 15, wherein a material for forming the first layer can be copper.

23. The method as claimed in claim 15, wherein a material for forming the first layer can be selected from the group consisting of copper, gold, silver, tin, aluminum, platinum, palladium, and metal alloys of previous metals.

24. The method as claimed in claim 15, wherein a material for forming the second layer can be copper.

25. The method as claimed in claim 15, wherein a material for forming the second layer can be selected from the group consisting of copper, gold, silver, tin, aluminum, platinum, palladium, and metal alloys of previous metals.

26. The method as claimed in claim 15, wherein the step of forming a plurality of first and second plugs comprises performing a through-hole electroplating process.

27. The method as claimed in claim 15, wherein the step of performing a drilling process comprises performing a drilling process assisted by laser-alignment.

28. A microelectronic system for detecting a bulge site, wherein the microelectronic system includes a reaction region, the system comprising:
a plurality of micro-locations distributed in the reaction region, wherein each micro-location comprises:
a first electrode disposed in a center of the micro-location;
a second electrode surrounding the first electrode with a distance, thus enclosing a space, wherein the second electrode is electrically insulated from the first electrode without loaded fluid;
an attachment layer coupled to a surface of the first electrode;
a plurality of binding entities coupled the attachment layer, wherein the binding entities are immobilized onto the surface of the first electrode through the attachment layer; and
a permeation layer for supporting the binding entities
, wherein the second electrodes isolate the first electrodes, acting as isolating walls, and wherein the space enclosed by the second electrode can hold loaded fluid;
a retaining wall around the reaction region;
a plurality of contact pads disposed outside the reaction region and surrounding the reaction region, for electrical operation;
a connective circuitry for connecting the first electrodes in the micro-locations and the contact pads;
an insulating layer for isolating the micro-locations and the connective circuitry, wherein the micro-locations are disposed on a first surface of the insulating layer and using the insulating layer as a base for the micro-locations, while a second surface of the insulating, opposite to the first surface, is attached to the connective circuitry;
a cap layer over the micro-locations for sealing the micro-locations in the reaction region;
a solution, including a plurality of test sample molecules, a redox-active mediator and an oxidant, added to the micro-locations in the sealed reaction region, wherein the test sample molecule can form a binding pair with the binding entity, thus forming a bulge site; and
a reference electrode applied to the micro-location for detecting the bulge site through the redox-active mediator.

29. The microelectronic system as claimed in claim 28, wherein the redox-active mediator is a metal complex compound for detecting the bulge site.

30. The microelectronic system as claimed in claim 29, wherein the metal complex compound can be selected from the group consisting of cobalt (II) (hexaazacyclophane)(trifuoroacetate)₂, cobalt (II) (hexaazacyclophane)(H2O) (trifuoroacetate), ruthenium (II) (hexaazacyclophane) (trifioroacetate)₂, and manganese (II) (hexaazacyclophane) (trifuoroacetate)₂.

31. The microelectronic system as claimed in claim 28, wherein the oxidant is hydrogen peroxide.

32. The microelectronic system as claimed in claim 28, wherein a power supply can be further included.

33. The microelectronic system as claimed in claim 28, wherein a material for forming the insulating layer can be selected from the group consisting of plastic, polyester (PET), polyimide (PI), polystyrene (PS) and glass materials.

34. The microelectronic system as claimed in claim 28, wherein a material for forming the first electrode can be selected from the group consisting of copper, gold, silver, tin, aluminum, platinum, palladium, and metal alloys of previous metals.

35. The microelectronic system as claimed in claim 28, wherein a material for forming the second electrode can be selected from the group consisting of copper, gold, silver, tin, aluminum, platinum, palladium, and metal alloys of previous metals.
